(19) United States
(12) Patent Application Publication
(10) Pub. No.: US 2009/0034534 A1
(43) Pub. Date: Feb. 5, 2009

(54) SYSTEM AND METHOD FOR ESTABLISHING AND MANAGING MULTIMEDIA SESSIONS BETWEEN TERMINALS

(76) Inventor: Stefano Faccin, Fremont, CA (US)

Correspondence Address: HARNESS, DICKEY & PIERCE P.L.C., 5445 CORPORATE DRIVE, SUITE 200, TROY, MI, 48098, US

(21) Appl. No.: 12/182,168

(22) Filed: Jul. 30, 2008

Related U.S. Application Data
(60) Provisional application No. 60/952,730, filed on Jul. 30, 2007.
(60) Provisional application No. 60/953,297, filed on Aug. 1, 2007.

(51) Int. Cl. H04L 12/58

(52) U.S. Cl. 370/395.52

(57) ABSTRACT

A source communication terminal includes a communication module that initiates a first communication with a first remote terminal via first Internet protocol (IP) multimedia subsystems (IMS) of a first IP network. The first communication includes X media components. The source communication terminal also includes a media transfer module that transfers Y of the X media components to a first target terminal of Z target terminals during the first communication. The source communication terminal also includes a control module that provides an indication to the first IMS of a control model for the first communication. The control model is implemented after the Y media components have been transferred to the first target terminal. The control model identifies at least one of the source communication terminal and the first target terminal that controls IMS signalling for the first communication. X, Y and Z are integers greater than or equal to 1, and Y is less than or equal to X.

### CROSS-REFERENCE TO RELATED APPLICATIONS

This application claims the benefit of U.S. Provisional Application Nos. 60/952,730, filed on Jul. 30, 2007 and 60/953,297, filed on Aug. 1, 2007. The disclosures of the above applications are incorporated herein by reference in their entirety.

### FIELD

The subject matter of the present disclosure relates to communication systems, and more particularly to protocols for managing multimedia sessions between terminals.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Referring now to FIG. 1, a functional block diagram of a wireless communications system 10 is presented. An Internet protocol (IP) network 12 receives packets from and sends packets to a multimedia device, such as first user equipment (UE) 13. The UE 13 may include a terminal that is capable of receiving voice, video and/or text signals. Examples of UEs include mobile phones, personal digital assistants (PDAs), video projectors, computers, etc. The IP network 12 may include, for example, a home public land mobile network (HPLMN) or a visited public land mobile network (VPLMN) of a 3^{rd} Generation Partnership Project (3GPP™) network system.

The first UE 13 may wirelessly connect to the IP network 12. An Internet protocol multimedia subsystem (IMS) 14 of the IP network 12 may implement communications between the first UE 13 and a second UE 16. The second UE 16 may be part of a distributed communications system, such as the Internet.

The first UE 13 may be, for example, a mobile phone, and the IP network 12 may be the cellular network of a mobile phone operator. In various implementations, the first UE 13 may be able to view content from the second UE 16 via the IP network 12. The IP network 12 may also interconnect with the networks of other service providers.

In FIG. 1, the first UE 13 and additional terminals, such as third and fourth UEs 18, 20, respectively, may be commonly controlled by a user. For example, the user may transfer media components of an ongoing communication session between the UEs 13, 18, 20. For example, the first and second UEs 13, 16 may be involved in a communication session that includes voice and video media components. Subsequently, the voice component is transferred from the first UE 13 to the third UE 18 and the video component is transferred from the first UE 13 to the fourth UE 20.

Referring now to FIG. 2, the first UE 13 may have an ongoing communication session including three media components, such as voice, video and text. Subsequently, only one of the media components of the session, such as the voice component, may be transferred to, for example, the third UE 18. The other components, such as video and text, may either resume on the second UE 16 or may be released to other UEs under the control of the user.

Referring now to FIG. 3, the first UE 13 may also retrieve from the third and fourth UEs 18, 20, respectively, media components, such as voice and video components. The components may have been previously active on the first UE 13. Further, the retrieval of the media components by the first UE 13 may occur during a communication session.

Referring now to FIG. 4, the first UE 13 may have an ongoing communication session that only includes one component, such as a voice component. Subsequently, an additional component, such as a video component, is added to the communication session. The additional component may be targeted towards another UE in common control of the user, such as the third UE 18.

### SUMMARY

A source communication terminal includes a communication module that initiates a first communication with a first remote terminal via first Internet protocol (IP) multimedia subsystems (IMS) of a first IP network. The first communication includes X media components. The source communication terminal also includes a media transfer module that transfers Y of the X media components to a first target terminal of Z target terminals during the first communication. The source communication terminal also includes a control module that provides an indication to the first IMS of a control model for the first communication. The control model is implemented after the Y media components have been transferred to the first target terminal. The control model identifies at least one of the source communication terminal and the first target terminal that controls IMS signalling for the first communication. X, Y and Z are integers greater than or equal to 1, and Y is less than or equal to X.

In other features, the media transfer module transfers M-Y of the X media components to a second target terminal of the Z target terminals during the first communication. The media transfer module transfers a first media component of the X media components to a second target terminal of the Z target terminals and a second media component of the X media components to a third target terminal of the Z target terminals. The transfers occur during the first communication. The source communication terminal also includes a receive module that receives the IMS signalling based on the control model. The receive module receives the IMS signalling independent of whether the source communication terminal or the first target terminal controls the IMS signalling for the first communication.

In other features, the source communication terminal includes a processing module that processes the IMS signalling and that forwards the IMS signalling to the first target terminal. The source communication terminal also includes a decision module that determines whether to accept the IMS signalling based on negotiations between the source communication terminal and the first target terminal. The source communication terminal further includes a session module that initiates the IMS signalling after the transfer of the Y of the X media components and that provides the IMS signalling to the first IMS. The IMS signalling includes signalling for communication with at least one of the first remote terminal and a second remote terminal.

In other features, the source communication terminal includes a security module that exchanges security information with the first target terminal. The exchanges of the security information include the source communication terminal receiving at least one token from the first target terminal. The security module provides the first IMS with the at least one token during the IMS signalling.

In other features, a network system includes the source communication terminal, the first IP network comprising the first IMS and the Z target terminals. At least one of the first IMS and the Z target terminals store the control mode. The first IMS selects the control model based on the indication from the source communication terminal. The first target terminal receives the IMS signalling from at least one of the first IMS and the source communication terminal. The source communication terminal provides at least one of an indication to the first target terminal that the IMS signalling is accepted by the source communication terminal and an instruction from the source communication terminal. The instruction instructs the first target terminal as to how it should handle the IMS signalling.

In other features, the first IMS selectively notifies at least one of the source communication terminal and the first target terminal of incoming IMS signalling. The incoming IMS signalling is for at least one of a first communication and a second communication from at least one of the first remote terminal and a second remote terminal. At least one of the first IMS and the first target terminal notifies the source communication terminal of changes to the first communication after the Y of the X media components have been transferred to the first target terminal. The changes include at least one of a change in control of one of the X media components, an addition of a media component to the first communication and a subtraction of one of the X media components from the first communication.

In other features, the system includes a second IP network including a second IMS. The first target terminal communicates with the second IMS. The first target terminal exchanges security data with the source communication terminal. The source communication terminal provides at least one of the first IMS and the second IMS with the security data during IMS signalling for the first communication. The security data may include a security token that originates from one of the source communication terminal and the first target terminal. The security data may also include a security key established between the source communication terminal and the first target terminal. The security data may also include a security association between the source communication terminal and the first target terminal.

In other features, the first target terminal includes a credential that identifies the first target terminal. The first target terminal is registered with the second IMS and not the first IMS. The second IMS provides IMS services based on the credential.

In other features, a method for operating a source communication terminal includes initiating a first communication with a first remote terminal via first Internet protocol (IP) multimedia subsystems (IMS) of a first IP network. The first communication includes X media components. The method also includes transferring Y of the X media components to a first target terminal of Z target terminals during the first communication. The method also includes providing an indication to the first IMS of a control model for the first communication. The method also includes implementing the control model after the Y media components have been transferred to the first target terminal. The control model identifies at least one of the source communication terminal and the first target terminal that controls IMS signalling for the first communication. X, Y and Z are integers greater than or equal to 1, and Y is less than or equal to X.

In other features, the method includes transferring M-Y of the X media components to a second target terminal of the Z target terminals during the first communication. The method also includes transferring a first media component of the X media components to a second target terminal of the Z target terminals and a second media component of the X media components to a third target terminal of the Z target terminals during the first communication. The method also includes receiving the IMS signalling based on the control model. The method also includes receiving the IMS signalling independent of whether the source communication terminal or the first target terminal controls the IMS signalling for the first communication.

In other features, the method includes processing the IMS signalling and forwarding the IMS signalling to the first target terminal. The method also includes determining whether to accept the IMS signalling based on negotiations between the source communication terminal and the first target terminal. The method also includes initiating the IMS signalling after the transfer of the Y of the X media components and providing the IMS signalling to the first IMS. The IMS signalling includes signalling for communication with at least one of the first remote terminal and a second remote terminal. The method also includes exchanging security information with the first target terminal. The exchanges of the security information include the source communication terminal receiving at least one token from the first target terminal.

In other features, the method includes providing the first IMS with the at least one token during the IMS signalling. The first IMS selects the control model based on the indication from the source communication terminal. The method also includes receiving the IMS signalling from at least one of the first IMS and the source communication terminal. The method also includes providing at least one of an indication to the first target terminal that the IMS signalling is accepted by the source communication terminal and an instruction from the source communication terminal as to how the first target terminal should handle the IMS signalling. The method also includes receiving notification of incoming IMS signalling for at least one of a first communication and a second communication from at least one of the first remote terminal and a second remote terminal.

In other features, a source communication terminal includes communication means for initiating a first communication with a first remote terminal via first Internet protocol (IP) multimedia subsystems (IMS) of a first IP network. The first communication includes X media components. The source communication terminal also includes media transfer means for transferring Y of the X media components to a first target terminal of Z target terminals during the first communication. The source communication terminal also includes control means for providing an indication to the first IMS of a control model for the first communication. The control model is implemented after the Y media components have been transferred to the first target terminal. The control model identifies at least one of the source communication terminal and the first target terminal that controls IMS signalling for the first communication. X, Y and Z are integers greater than or equal to 1, and Y is less than or equal to X.

In other features, the media transfer means transfers M-Y of the X media components to a second target terminal of the Z target terminals during the first communication. The media transfer means transfers a first media component of the X media components to a second target terminal of the Z target terminals and a second media component of the X media components to a third target terminal of the Z target terminals. The transfers occur during the first communication. The source communication terminal also includes receive means for receiving the IMS signalling based on the control model. The receive means receives the IMS signalling independent of whether the source communication terminal or the first target terminal controls the IMS signalling for the first communication.

In other features, the source communication terminal includes processing means for processing the IMS signalling and for forwarding the IMS signalling to the first target terminal. The source communication terminal also includes decision means for determining whether to accept the IMS signalling based on negotiations between the source communication terminal and the first target terminal. The source communication terminal further includes session means for initiating the IMS signalling after the transfer of the Y of the X media components and for providing the IMS signalling to the first IMS. The IMS signalling includes signalling for communication with at least one of the first remote terminal and a second remote terminal.

In other features, the source communication terminal includes security means for exchanging security information with the first target terminal. The exchanges of the security information include the source communication terminal receiving at least one token from the first target terminal. The security means provides the first IMS with the at least one token during the IMS signalling.

In other features, a network system includes the source communication terminal, the first IP network comprising the first IMS and the Z target terminals. At least one of the first IMS and the Z target terminals store the control mode. The first IMS selects the control model based on the indication from the source communication terminal. The first target terminal receives the IMS signalling from at least one of the first IMS and the source communication terminal. The source communication terminal provides at least one of an indication to the first target terminal that the IMS signalling is accepted by the source communication terminal and an instruction from the source communication terminal. The instruction instructs the first target terminal as to how it should handle the IMS signalling.

In other features, the first IMS selectively notifies at least one of the source communication terminal and the first target terminal of incoming IMS signalling. The incoming IMS signalling is for at least one of a first communication and a second communication from at least one of the first remote terminal and a second remote terminal. At least one of the first IMS and the first target terminal notifies the source communication terminal of changes to the first communication after the Y of the X media components have been transferred to the first target terminal. The changes include at least one of a change in control of one of the X media components, an addition of a media component to the first communication and a subtraction of one of the X media components from the first communication.

In other features, the system includes a second IP network including a second IMS. The first target terminal communicates with the second IMS. The first target terminal exchanges security data with the source communication terminal. The source communication terminal provides at least one of the first IMS and the second IMS with the security data during IMS signalling for the first communication. The security data may include a security token that originates from one of the source communication terminal and the first target terminal. The security data may also include a security key established between the source communication terminal and the first target terminal. The security data may also include a security association between the source communication terminal and the first target terminal.

In other features, the first target terminal includes a credential that identifies the first target terminal. The first target terminal is registered with the second IMS and not the first IMS. The second IMS provides IMS services based on the credential.

Further areas of applicability of the present disclosure will become apparent from the detailed description provided hereinafter. It should be understood that the detailed description and specific examples, while indicating various embodiments of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1-4 are functional block diagrams of a conventional network system;

FIG. 5-6B are functional block diagrams of an example network system;

FIG. 7 is an example functional block diagram of a control module for a multimedia subsystem;

FIGS. 8A-8B are examples of functional block diagrams of a mobile terminal;

FIGS. 9A-9B illustrate an example method for setting up a control model;

FIGS. 10A-11B illustrate example methods for modifying IMS communications;

FIGS. 12A-12B illustrate an example method for setting up a new IMS communication;

FIGS. 13A-14B illustrate example methods for modifying an IMS communication;

FIGS. 15A-15B illustrate an example method for setting up a new IMS communication; and

FIGS. 16A-21B illustrate examples of methods for setting up and implementing security for IMS communications.

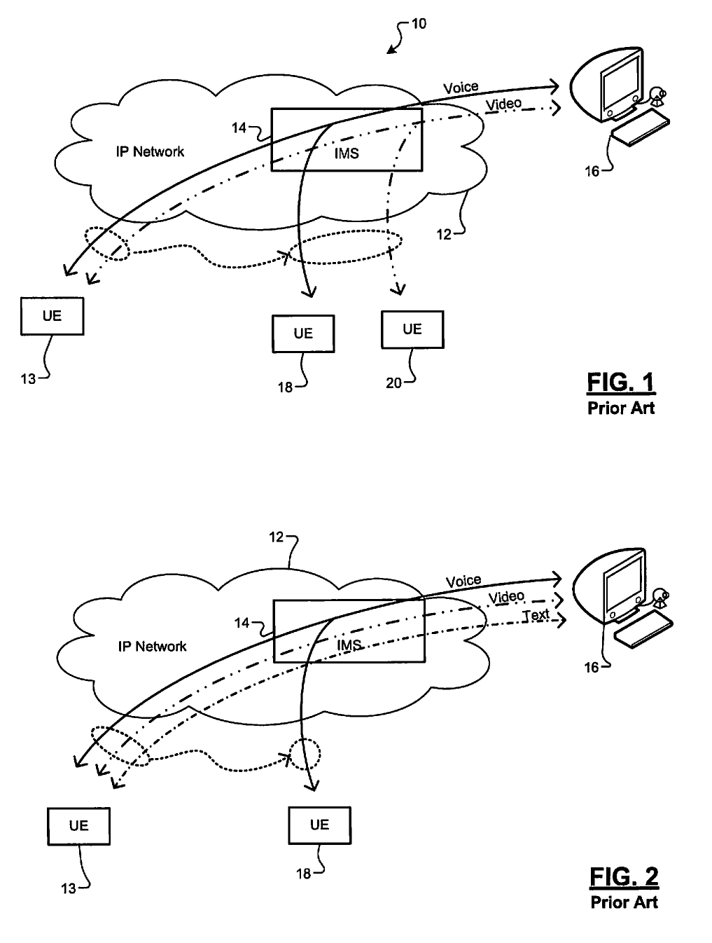

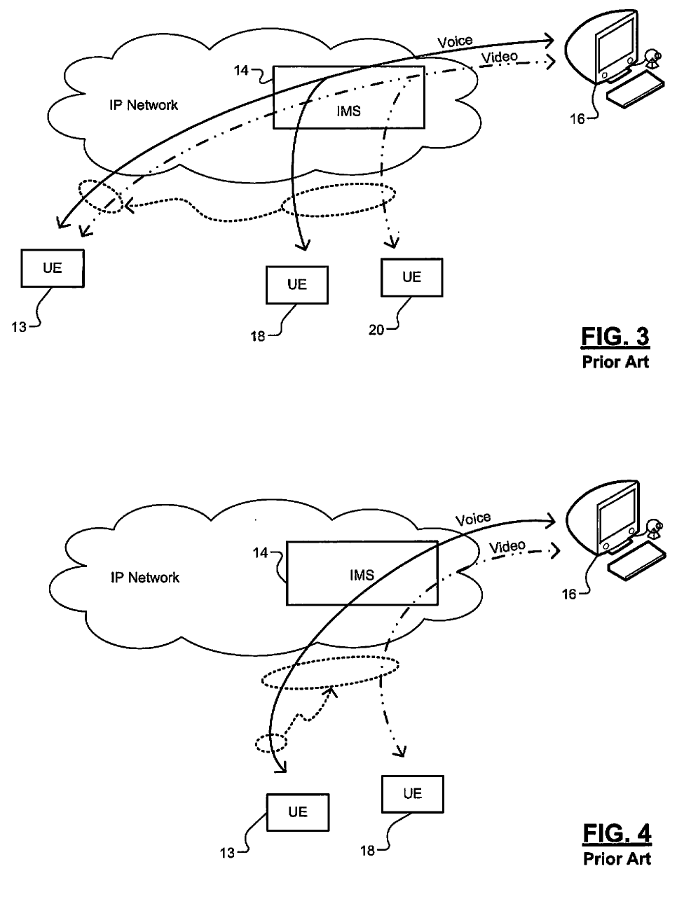

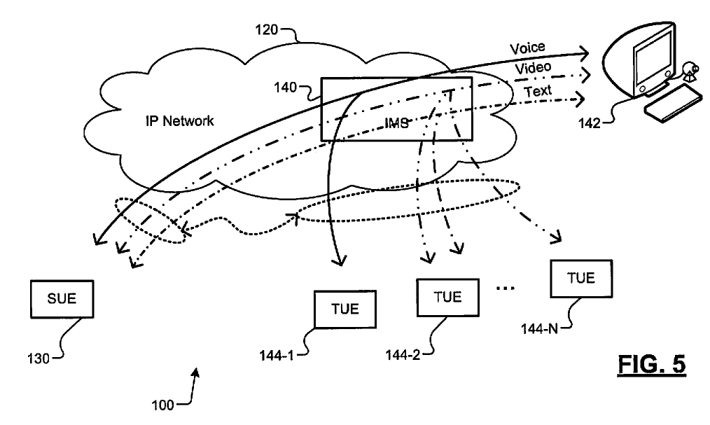

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that one or more steps within a method may be executed in different order (or concurrently) without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

The present disclosure describes a system and method for source multimedia user equipment (SUE) (e.g., a source communication terminal) to exchange a subset of media components of an ongoing multimedia communication session with target multimedia user equipment (TUE(s)). The result of the exchange may be referred to as a modified media setup. The exchange and subsequent control of the communication session may be based on a control model, which, when implemented, directs control for IMS communication sessions. The UEs may also be permitted to add components to an ongoing IMS communication session. The UEs may be under control of the same user as the first UE or under control of a different user. The UEs may be registered with one or more Internet protocol (IP) networks that provide IP multimedia services. The UEs may have respective credentials to register with the IP networks and to establish and/or receive IP multimedia services. The UEs may also exchange security information and use the security information to implement the exchange of media components.

Referring now to FIG. 5, a functional block diagram of an example wireless communications system 100 is shown. An IP network 120 receives packets from and sends packets to a multimedia device, such as a SUE 130. The SUE 130 may have an ongoing communication session including a plurality of media components, such as voice, video and/or text. Subsequently, one or more of the media components of the session, such as the voice component, may be transferred to one or more TUEs 144-1, 144-2, . . . , 144-N (referred to herein as TUEs 144). The other components, such as video and text, may either continue on the SUE 130 or may be released to other TUEs 144. Subsequently, an additional component, such as a video component, may be added to the communication session. The additional component may be targeted towards and/or implemented by the TUEs 144 and/or the SUE 130.

Examples of UEs (i.e., the SUE 130 and TUEs 144) include mobile phones, personal digital assistants (PDAs), video projectors, computers, etc. The IP network 120 may include, for example, a home public land mobile network (HPLMN) or a visited public land mobile network (VPLMN) of a 3^{rd} Generation Partnership Project (3GPP™) network system. The specifications for the 3GPP are incorporated herein by reference in their entirety.

The SUE 130 may wirelessly connect to the IP network 120. An Internet protocol multimedia subsystem (IMS) 140 of the IP network 120 may implement communications between the SUE 130 and one or more core network (CN) UE(s) 142. The CN UE 142 may be part of a distributed communications system, such as the Internet. In various implementations, the SUE 130 may be able to view content from the CN UE 142 via the IP network 120. The IP network 120 may also interconnect with the networks of other service providers.

In FIG. 5, the SUE 130 and TUEs 144 may be commonly controlled by one or more users. For example, the user may transfer media components of an ongoing communication session between the SUE 130 and one or more of the TUEs 144. For example, the SUE 130 and CN UE 142 may be involved in a communication session that initially includes voice and video media components. Subsequently, the voice component is transferred from the SUE 130 to the TUE 144-1 and the video component is transferred from the SUE 130 to the TUE 144-2. The SUE 130 may remain in complete control of communication sessions (e.g., the voice component and the video component) even after media is transferred to the TUEs 144. Alternatively, the TUEs 144 may gain control of the media components, and the SUE 130 is merely notified of changes to media components and/or IMS signalling.

The SUE 130 and the TUEs 144 may alternatively be controlled by different users and may be located remotely. The TUEs 144 may be registered with the IMS 140, may be registered with another IMS and not the IMS 140, or may not be registered with an IMS. The SUE 130 may exchange and/or provide credentials and/or other security information to the TUEs 144 to allow the TUEs 144 to register with the IP network 120 and to establish/receive IP multimedia services.

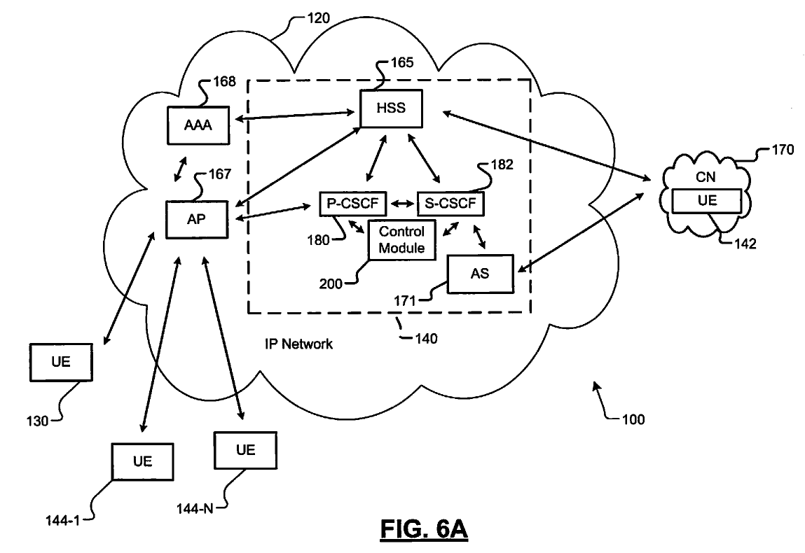

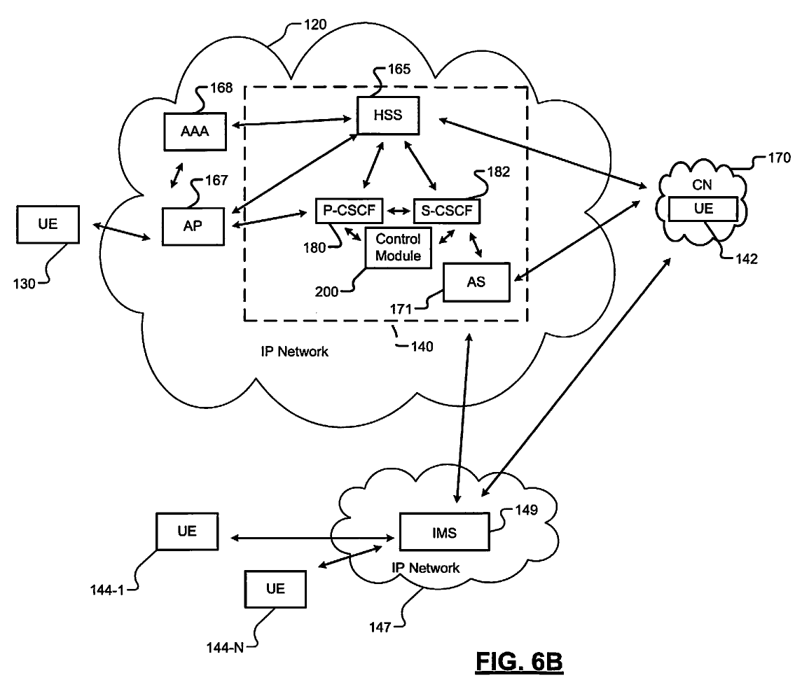

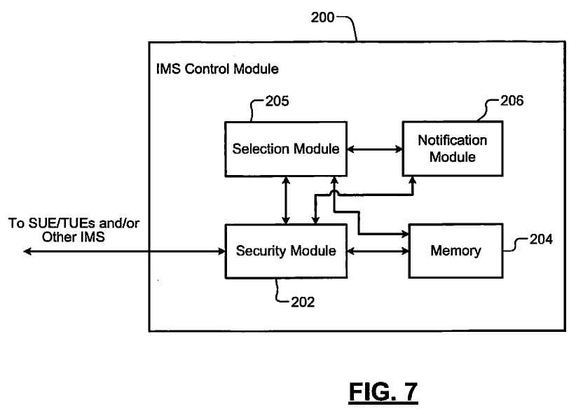

Referring now to FIGS. 6A-6B, the network system 100 is illustrated in more detail. In FIG. 6A, the SUE 130 and TUEs 144 communicate with the same IP network 120. In FIG. 6B, one or more of the TUEs 144 communicate with one or more different IP networks 147. The additional IP network(s) may also include an IMS 149. The IMS 149 may communicate with the IMS 140 and/or the core network 170. The IP network 120 may include a home subscriber server (HSS) 165 that is in communication with an authentication, authorization and accounting (AAA) server 168.

The HSS 165 may consider each UE as a subscriber to the core network 170 and may include authentication and subscription data required for the UEs to access the core network 170. The HSS 165 may also store an IP address of the AAA server 168 to which the SUE 130 is registered. The AAA server 168 provides AAA information and subscriber profile information. This information may be obtained from the HSS 165. For example, the AAA server 168 may authenticate UE subscription information with the HSS 165 after a request to communicate by the SUE 130.

For example, when accessing the IMS 140, the SUE 130 generates and transmits an access authentication signal to the HSS 165 and/or the AAA server 168. The SUE 130 and/or TUEs 144 may attach to the IP network 120 via one or more attachment points (AP) 167. An attachment point 167 may include a radio access network, such as an Evolved Universal Terrestrial Radio Access Network (EUTRAN) or a Long Term Evolution (LTE) radio access network (RAN). The SUE 130 and/or TUEs 144 may alternatively be located in a non-3GPP™ network, such as a wireless local area network (WLAN) network or Worldwide Interoperability for Microwave Access (WiMAX) network. The non-3GPP™ network may communicate with the IP network 120 via non-3GPP™ attachment points (not shown). Any of the attachment points may communicate according to any of IEEE standards 802.11, 802.11a, 802.11b, 802.11g, 802.11h, 802.11n, 802.16, and 802.20, which are incorporated herein by reference in their entirety.

Following establishment of IP connectivity, an attachment procedure between the SUE 130 and the attachment point 167 may be completed. The SUE 130 may then register with the IMS 140. The SUE 130 may receive IMS resources from the core network 170 via the IMS 140. IMS resources may include real-time and non-real-time resources, such as Web browsing, voice over Internet phone (VoIP), electronic mail (email), real-time IP multimedia, and conversational and streaming resources. The aforementioned example of registration and IMS resource use may also be similarly implemented by the TUEs 144.

The IMS 140 includes an architectural framework for delivering IP multimedia to the SUE 130 from the core network 170. The IMS 140 may include one or more application server(s) AS(s) 171. The AS 171 may include a software engine that delivers communications to devices, such as UE 142, in the core network 170. The IMS 140 may also include various devices that support multimedia exchanges that may be referred to as proxy servers. Proxy servers are servers, such as computer systems or application programs that service requests of the SUE 130 by forwarding requests to other servers within the core network 170. Exemplary proxy servers include a proxy Call Session Control Function (P-CSCF) 180 and a serving-Call Session Control Function (S-CSCF) 182. The proxy servers, P-CSCF 180 and S-CSCF 182, may generally be referred to as IMS sub-control modules.

The P-CSCF 180 may receive and inspect all messages received in the IMS 140. The P-CSCF 180 may also authenticate and establish security for the SUE 130 and/or TUEs 144 with regard to the IMS 140. The P-CSCF 180 may forward registration messages and session establishment messages to the IP network 120 from the SUE 130, TUEs 144 and/or other IMS. The P-CSCF 180 may also authorize IMS resources, control quality of service and manage IMS bandwidth.

The S-CSCF 182, which may also be referred to as a session module, sets up an IMS session and handles requests for use of multimedia delivered from the SUE 130. Requests for use of multimedia may include registration of the SUE 130 and/or TUEs 144 with the IMS 140 via Session Initiation Protocol (SIP) messages. SIP includes an application-layer control protocol for creating, modifying, and terminating sessions between two participants, such as the SUE 130 and a device, such as UE 142, within the core network 170. The HSS 165 may interface with the S-CSCF 182 to provide information about the location of the SUE 130 and UE subscription information. The S-CSCF 182 may interface with the HSS 165 and may download and upload user profiles for the SUE 130 and/or TUEs 144.

An exemplary SIP registration is specified in 3GPP TS 23.228, which is incorporated herein by reference in its entirety. SIP communications used in creation of sessions for media usage may be referred to as SIP signalling communications or, as used herein, IMS signalling. Communications that involve the actual usage of IMS media may be referred to as SIP media signals.

To provide a service at the request of the SUE 130, the S-CSCF 182 delivers an SIP message via the AS 171 to other entities in communication with the IMS 140, such as the UE 142. The S-CSCF 182 performs session management for the IMS 140. The S-CSCF 182 handles SIP messages, which allow the S-CSCF 182 to bind the location of the SUE 130 and/or TUEs 144 (for example, the UE IP address(es)) and an SIP address. The SIP address may correspond to a location of a device in the core network 170. Basically, the S-CSCF 182 determines to which device(s) SIP messages may be forwarded in order to provide resources requested by the SUE 130 and/or TUEs 144.

Referring now to FIG. 7, the IMS 140 may also include an IMS control module 200 that communicates with the P-CSCF 180 and S-CSCF 182. Alternatively, the IMS control module 200 may be distributed throughout the IMS 140 and at least in part throughout the P-CSCF 180 and S-CSCF 182.

The IMS control module 200 may include a security module 202 that determines whether the IMS 140 supports signalling with the TUEs 144 and/or modification of existing IMS communication sessions. The security module 202 may, for example, analyze incoming indicators, such as credentials, security keys, tokens, security associations and/or other indicator information from the SUE 130 and/or TUEs 144. The tokens may be single use or multiple use tokens. The security association may include data that provides and indication of an association between the SUE 130 and one or more of the TUEs 144 and/or the IMS 140. For example, the security association may include SUE/IMS registration information. The indicators may be provided in IMS signalling or in separate requests from the SUE 130 or TUEs 144. The control module 200 may store UE profiles that include credentials, security keys, tokens, security associations and/or other indicator information in memory 204. The security module 202 may compare incoming data with the data in the profiles.

The control module 200 may also include a selection module 205 that selectively allows TUEs 144 to use one or more media components. The SUE 130 and/or the TUEs 144 may request changes to an ongoing communication session involving one or more media components. The security module 202 may determine that the changes are allowed, and the selection module 205 may then implement the changes based on a control model.

The selection model 205 may select the control model from memory 204 based on an indicator provided by the SUE 130 during the communication session. For example, the selection module 205 may indicate to the S-CSCF 182 that selective media components are to be sent to the SUE 130 and other media components are to be sent to the TUEs 144. In one embodiment, the SUE 130 transfers all media components to the TUEs 144. The selection module 205 may also determine which of the SUE 130 and TUEs 144 retains control of communication sessions based on the control model. The control determination may be based on signals from the SUE 130 indicating that the SUE 130 is giving up some or all of the control and/or reception of communications and/or signalling.

The signals may indicate a control model that indicates which of the SUE 130 and TUEs 144 retains control of the various media components and how the IMS 140 will communicate with the SUE 130 and TUEs 144. For example, the control model may indicate that, even if the SUE 130 gives up communication session control, the SUE 130 may still receive notifications of updates to communication sessions from a notification module 206. The SUE 130 may request the notifications, and/or the notification module 206 may automatically transmit the notifications. The notification module 206 may selectively provide (in other words, choose to provide or not to provide) the notifications.

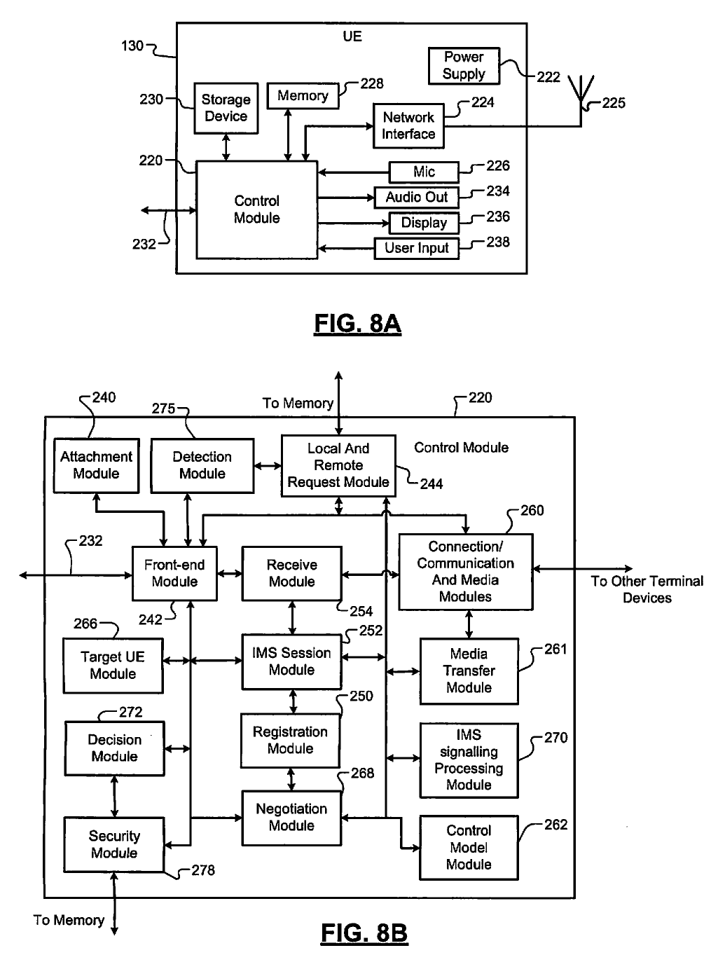

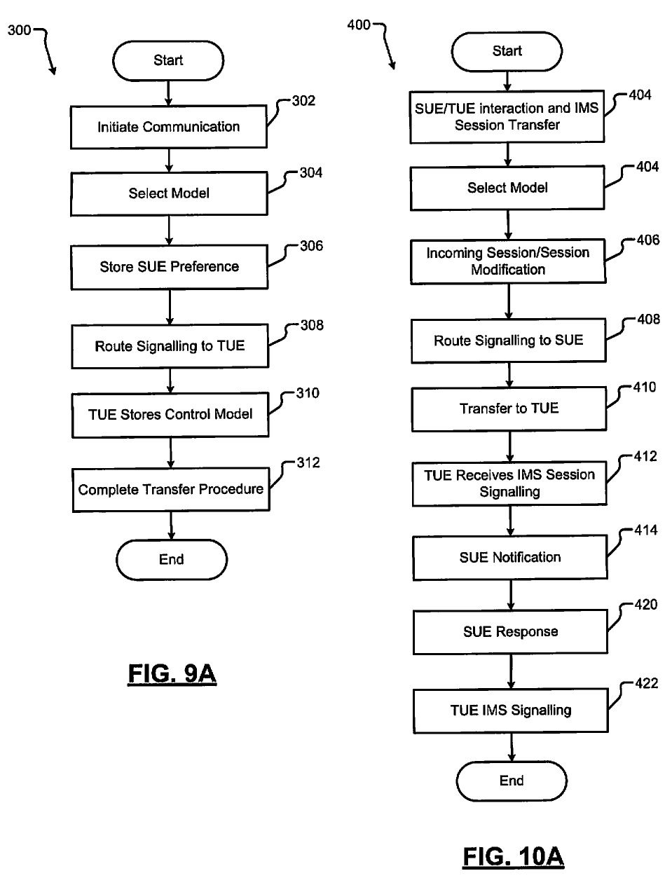

Referring now to FIGS. 8A-8B, an example of a UE, which may include a cellular phone or other type of communication terminal, is illustrated. The UE is illustrated with respect to an SUE 130, however, the TUEs 144 may also include any or all of the components shown in FIGS. 8A-8B. The SUE 130 includes a control module 220, a power supply 222, memory 228, a storage device 230, and a cellular network interface 232. The SUE 130 may include a network interface 224, a microphone 226, an audio output 234 such as a speaker and/or output jack, a display 236, and a user input device 238 such as a keypad and/or pointing device. If the network interface 224 includes a wireless local area network interface, an antenna 225 may be included.

The control module 220 may receive input signals from the cellular network interface 232, the network interface 224, the microphone 226, and/or the user input device 238. The control module 220 may process signals, including encoding, decoding, filtering, and/or formatting, and generate output signals. The output signals may be communicated to one or more of memory 228, the storage device 230, the cellular network interface 232, the network interface 224, and the audio output 234.

The memory 228 may store a terminal profile. The terminal profile may indicate the type of terminal and the capabilities of the SUE 130. The capabilities of the SUE 130 may include restrictions to the IMS 140, the core network 170 and/or devices within the core network 170. The memory 228 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 230 may include an optical storage drive, such as a DVD drive, and/or a hard disk drive (HDD). The power supply 222 provides power to the components of the SUE 130.

In FIG. 8B, the control module 220 may include an attachment module 240 that initiates attachment and authentication procedures via a front-end module 242. The request module 244 may request use of local and home resources, such as resources in the first and/or the core network 170. The request module 244 may therefore request access to the core network 170 during attachment procedures of the attachment module 240.

Alternatively, the request module 244 may request use of resources in the core network 170 during another procedure, such as IMS registration (before or during IMS signalling) and/or at the set-up of each IMS communication session. The control module 220 may receive responses from the IP network 120 in a receive module 254 that indicate that the SUE 130 may connect with the core network 170. The responses may include respective IP addresses for the connections, however, the IP addresses may be initially provided by each IMS in the respective networks.

The control module 220 may also include a registration module 250 and an IMS session module 252. The registration module 250 registers with the IMS 140 for use of IMS resources using, for example, SIP registration signals. The IMS session module 252 sets-up and maintains IMS sessions following SIP registration when the SUE 130 requires use of IMS resources. The session module 252 may initiate IMS signalling after the transfer of media components. The IMS signalling may include signalling for communication with one or more remote terminals, such as UE 142. A request module 244 may request transfer of media components during one or both of SIP registration and IMS session set-up.

The receive module 254 may receive signals from the IMS 140 that indicate whether media component transfer is permitted for IMS resources. Media transfer may not be allowed when the IMS resources are in use and/or otherwise not available or not recognized in the core network 170. Also, media component transfer may not be allowed if a profile for the SUE 130 and/or TUEs 144 indicates that the SUE 130 and/or TUEs 144 may not receive and/or transfer media components. The profile for the SUE 130 and/or TUEs 144 may be stored in memory 228 within the SUE 130, and/or in memory within the IP network 120.

The control module 220 may also include connection/communications and media modules 260 that control connection between network devices and that provide control for various terminal devices. Examples of terminal devices include the network interface 224, the microphone 226, and/or the user input device 238. The connection/communications and media modules 260 may initiate communications with remote terminals, such as the UE 142. The connection/communications and media modules 260 may also notify other UEs, such as the TUEs 144, of changes to an IMS communication and/or IMS signalling. Changes to the communication may include change in control of one of the media components and an addition or subtraction of a media component to the communication.

The control module 220 may also include a media transfer module 261 that implements transfer of one or more media components of an ongoing communication session to one or more TUEs 144. Transfer and control of the media components may be based on a control model that is selected by a control model module 262. The control model selection may indicate to the IMS 140 a control model for the ongoing communication session that is to be implemented after the media components have been transferred. Alternatively, the SUE 130 and/or one or more of the TUEs 144 may include the control model, where the control model is implemented by one or more of the SUE 130, the TUEs 144 and the IMS 140 based on signals from the SUE 130. The control model may indicate which of the SUE 130 and TUEs 144 will control IMS signalling for the ongoing communication session. For example, the control model may indicate that SUE 130 may retain control of the communication session and/or IMS signalling related to the communication session and/or other communication sessions. The control model may also indicate that the SUE 130 is transferring control of the communication session and/or other communication sessions to one or more of the TUEs 144. The control model may further indicate that the SUE 130 and/or the TUEs 144 may be notified of changes to the communication session and/or IMS signalling for the communication session.

The control module 220 may also include a target UE module 266 that signals at least one of the TUEs 144 of the transfer of the media components. The control module 220 may also include a negotiation module 268 that negotiates transfer of the media components with the TUEs 144 based on respective terminal capabilities. The control module 220 may also include a processing module 270 that processes IMS signalling and that may forward the IMS signalling to the TUEs 144. The control module 220 may also include a decision module 272 that determines whether to accept IMS signalling for the current communication session and/or subsequent communication sessions. For example, the decision module 272 may determine whether to accept the IMS signalling based on negotiations between the SUE 130 and the TUEs 144. The decision module 272 may notify other UEs and/or the IMS 140 of the determination. The notification may also include an indication as to how the SUE 130 will handle incoming IMS signalling and how TUEs are to handle the IMS signalling. The TUEs 144, which may also include respective decision modules 272, may accept or reject the indication from the decision module 272 of the SUE 130.

The control module 220 may also include a detection module 275 that determines the presence of TUEs 144 based on a user input and/or a search via a local connectivity interface for target terminals. An exemplary local connectivity interface is a Bluetooth interface. The control module 220 may also include a security module 278 that exchanges security information with the TUEs 144. The security module 278 may exchange the security information during IMS signalling for the ongoing communication session. The security information exchanges may include the SUE 130 receiving at least one token, key, security association or other information from the TUEs 144. The security module 278 may generate the security association based on data that identifies the SUE 130 and one or more TUEs 144. The security module 278 may provide the security information to the IMS 140 during the IMS signalling.

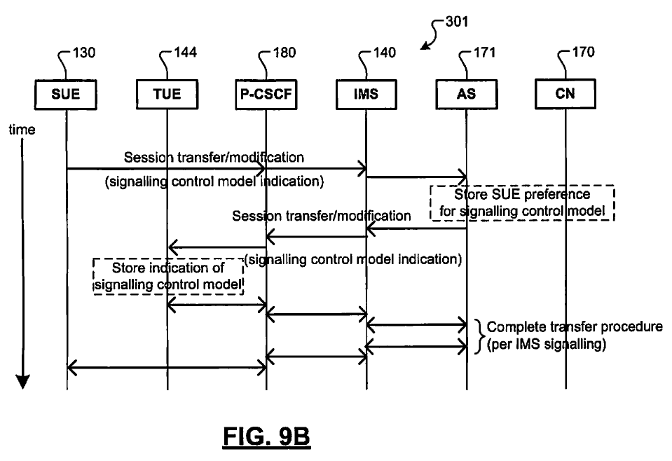

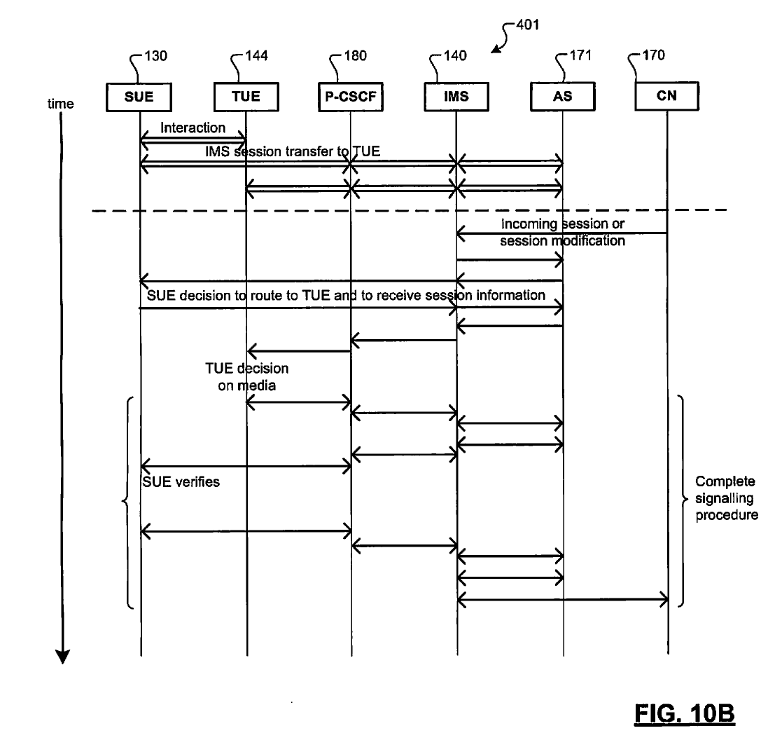

Referring now to FIG. 9A, a block diagram 300 illustrates a method by which the SUE 130 sets up a signalling control model while transferring a subset of a multimedia communication session to one or more TUEs 144. Further, FIG. 9B illustrates a timeline 301 of steps performed based on the method for transferring communication sessions. In step 302, the SUE 130 may initiate a communication session with a UE 142 in the core network 170 via modules within the IMS 140. IMS communication sessions may be initiated through the P-CSCF 180, which may be included within the IMS 140. The communication session may include one or more media components—e.g., voice, video and/or text components. In step 304, the SUE 130 may select a control model to be used for the multimedia communication session after one or more of the media components have been transferred to one or more TUEs 144. In step 306, the SUE 130 may initiate transfer of the IMS communication session. During the transfer, the SUE 130 may indicate to the IMS 140 the type of control model to be used after the IMS communication session has been transferred.

In step 306, the IMS 140 may store an indication of the signalling control model. In step 308, the IMS 140 may transfer media components of a communication session to the TUEs 144 and may implement the control model during the transfer. The transfer may include transferring one or more of the media components (up to and including all of the media components). The transfer of the media components and IMS signalling may also include negotiations between the SUE 130 and the TUEs 144. For example, the negotiations may determine features of the TUEs 144, such as media supported by the TUEs 144, etc. In other words, the SUE 130 may provide negotiation signals in communication sessions with the IMS 140, and the IMS 140 may provide the TUEs 144 with those negotiation signals. In step 310, the TUEs 144 may store an indication of the control model. In step 312, the SUE 130, TUEs 144 and the IMS 140 may complete the transfer of the IMS communication session.

Referring now to FIG. 10A, a block diagram 400 illustrates a method for IMS communication session modification where the SUE 130 retains communication control when session originates from the control network 170. Further, FIG. 10B illustrates a timeline 401 of steps performed based on the method for IMS communication session modification.

In step 402, the SUE 130 may transfer an IMS communication session to the TUEs 144, as in FIGS. 9A-9B. The SUE 130 may retain control of the IMS communication session after the transfer, independently of the amount of media components that have been transferred to the TUEs 144. In other words, the SUE 130 may transfer media components to TUEs 144 and still receive incoming IMS session signalling. Therefore, the IMS 140 may respond to the SUE 130 for communication sessions that occur after transfer of media components. The IMS 140 may also select the control model to be used for the IMS communication session.

In step 406, the IMS 140 may receive an incoming IMS session from the core network 170 and send the incoming IMS session signalling to the SUE 130 in step 408. The IMS 140 may receive the communication session from the UE 142 and may respond to the TUEs 144 and/or the SUE 130. The IMS 140 may also select a control model to be used for the communication session. The incoming IMS session may include signalling related to a new communication session and/or signalling related to media modification for the existing communication session. The SUE 130 may process the incoming IMS session signalling and may determine whether to accept the incoming new communication session or media modification. The determination may include using the information the SUE 130 and TUEs 144 have negotiated when the IMS communication session transfer took place. The SUE 130 may indicate the acceptance by providing information about the specific media that the TUE 144 may accept. Alternatively, the SUE 130 may indicate the acceptance by providing information about the specific media that the TUEs 144 may accept or modify.

In step 410, the SUE 130 may forward the IMS session signalling to the TUEs 144. The SUE 130 may completely transfer control of the IMS communication session to the TUEs 144 for session modification, new outgoing communication sessions, and/or for new incoming communication sessions. The SUE 130 may then forward the IMS session signalling to the TUEs 144 and may indicate to TUEs 144 that the incoming new communication session or media modification is accepted. In step 412, the TUEs 144 may receive the IMS session signalling and accept or decline signalling for media components. For example, the TUEs 144 may accept or decline signalling based on a TUE profile that indicates that the TUEs 144 may not be able to support certain media components. In step 414, the IMS 140 may notify the SUE 130 of the IMS communication session status at the end of the media negotiation. Negotiations may be completed by the IMS 140 providing the TUEs 144 with negotiation information from the SUE 130. The incoming IMS session signalling may include signalling related to a new and/or existing communication session. The IMS 140 may select the control model while determining where to route the IMS signalling.

The TUEs 144 may process the incoming IMS session signalling. TUE signal processing may include performing actions related to the media components based on the information provided by the SUE 130. The TUE signal processing may also include determining whether to perform the actions related to the media components based on the information provided by the SUE 130.

The SUE 130 may, however, provide a control signal to the IMS 140 that indicates that the SUE 130 may receive notifications of events that occur in the IMS communication session, such as change of media, addition of media, deletion of media, etc. The control signal may be based on SUE policies and/or information from the TUEs 144 obtained by the SUE 130 during the interaction of step 402.

While the TUEs 144 are determining whether to perform the actions related to the media components, the TUEs 144 may also complete the IMS signalling procedure by indicating to the SUE 130 the media components that were modified and how the media components were modified.

In step 420, when the SUE 130 is notified of events, such as a TUE 144 accepting or declining signalling related to media components, the SUE 130 may selectively cause the media modification and/or the IMS communication session to be transferred back to the SUE 130 and/or to other TUEs 144. In step 422, the TUEs 144 to whom the SUE 130 has transferred a subset of a communication session may initiate IMS session signalling towards the core network 170. For example, the TUEs 144 may send the signalling to the IMS 140. The IMS 140 may process the IMS session signalling sent by the TUE 144. The IMS 140 may forward the signalling to the core network 170. Reception of incoming IMS session signalling may include completion of the IMS communication session signalling procedure according to IMS procedures. The completion of the IMS communication session signalling procedure according to IMS protocol may include routing the IMS signalling according to the routing procedure that was used at the initiation of the procedure based on the control model or independent of the control model.

Referring now to FIG. 11A, a block diagram 500 illustrates a method for IMS communication session modification where the SUE 130 retains communication session control after the transfer of FIGS. 9A-9B. In FIG. 11A, the IMS session originates from the SUE 130. For example, the SUE 130 may send the signalling to the IMS 140, and the IMS 140 may process the IMS session signalling. The IMS 140 may forward the IMS signalling to the core network UE 142. Further, FIG. 11B illustrates a timeline 501 of steps performed based on the method for IMS communication session modification.

In step 504, the SUE 130 may transfer an IMS communication session to the TUEs 144, as in FIGS. 9A-9B. In step 506, the SUE 130 may initiate an IMS session modification. In other words, the SUE 130 may initiate the IMS session signalling towards a core network UE 142 and may also provide signalling related to a new and/or existing communication session to the IMS 140. The IMS 140 may process the IMS session signalling via determining whether to forward all or part of the IMS session signalling to the TUEs 144. The IMS processing may also include notifying the TUEs 144 of the media information, such as which media components will be transferred, via the IMS session signalling.

In step 508, the IMS 140 may provide the TUEs 144 with the session modification, and the TUEs 144 may accept or decline the proposed modification. Two options, labelled as “A” and “B” are illustrated in FIG. 11B for step 508. For option A, all signalling is routed through the TUEs 144. For option B, the TUEs 144 are merely informed of media information that is to be setup. The TUEs 144 may process the incoming IMS session signalling. The IMS session signalling may include an indication that IMS communication session signalling procedures have been completed according to IMS procedures for a particular communication session. In step 510, the IMS session modification is completed. In step 512, IMS communication sessions may be implemented via the modified media setup.

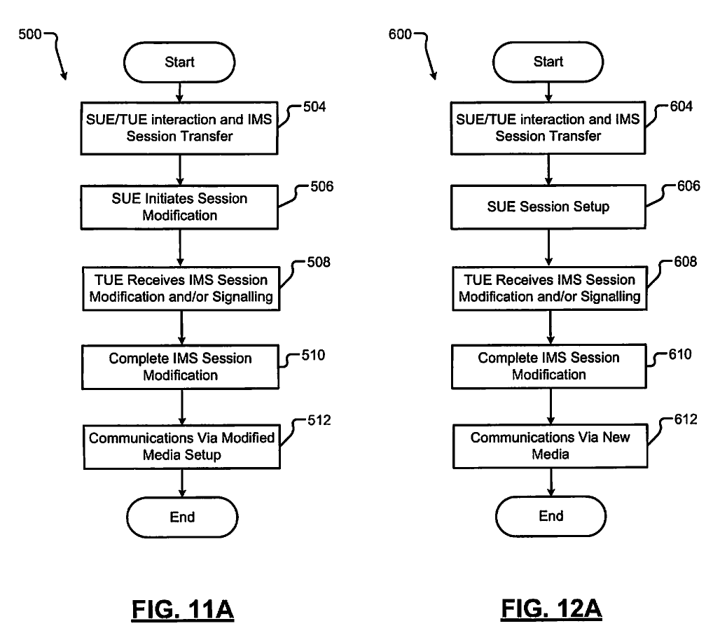

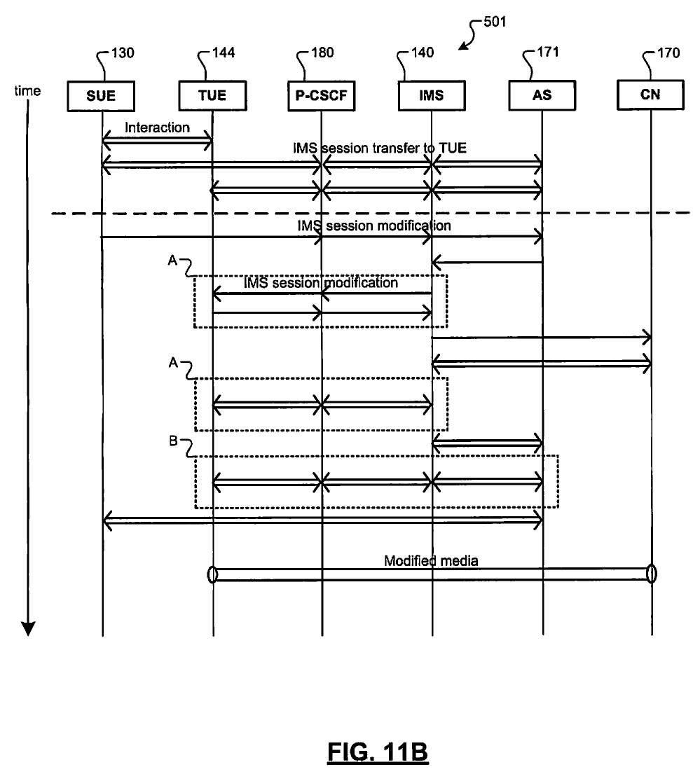

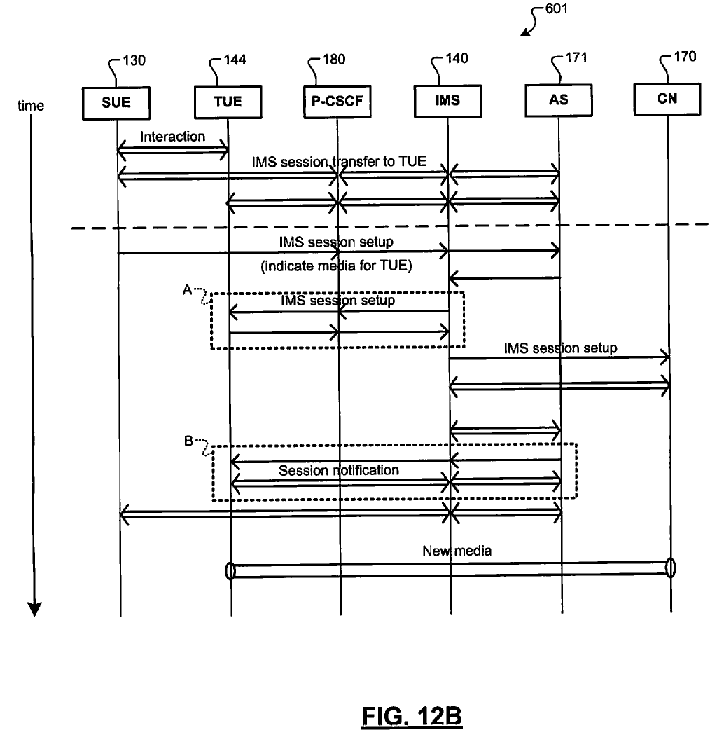

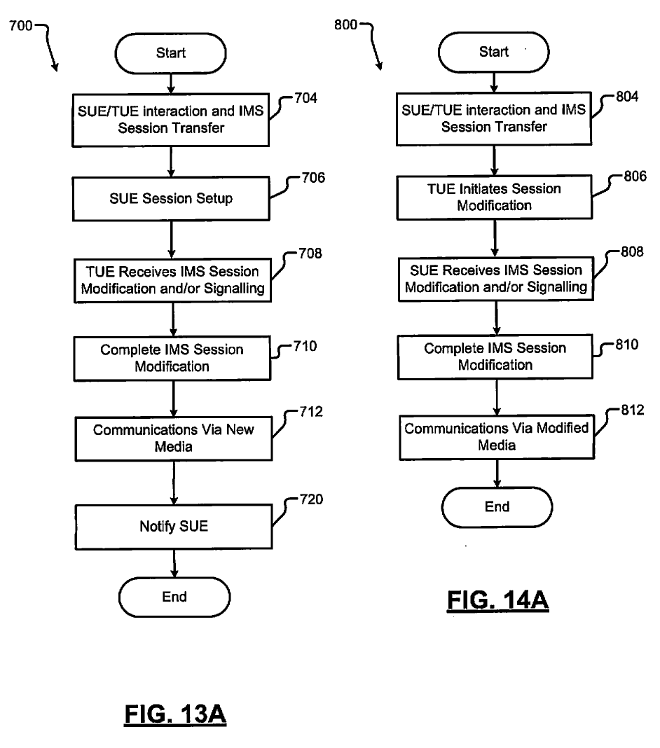

Referring now to FIG. 12A, a block diagram 600 illustrates a method for the SUE 130 to originate a new IMS communication session setup where the SUE 130 retains communication session control and where the TUEs 144 receive media components. Further, FIG. 12B illustrates a timeline 601 of steps performed based on the method for IMS communication session setup.

In step 604, the SUE 130 may transfer an IMS communication session to the TUEs 144, as in FIGS. 9A-9B. In step 606, the SUE 130 may initiate an IMS session setup and indicate media components to be transferred to the TUEs 144. In step 608, the IMS 140 may provide the TUEs 144 with the session modification, and the TUEs 144 may accept or decline the proposed modification. Two options, labelled as “A” and “B” are illustrated in FIG. 12B for step 608. For option A, all signalling is routed through the TUEs 144. For option B, the TUEs 144 are merely informed of media information that is to be setup. In step 610, the IMS session modification is completed. In step 612, IMS communication sessions may be implemented via the new media.

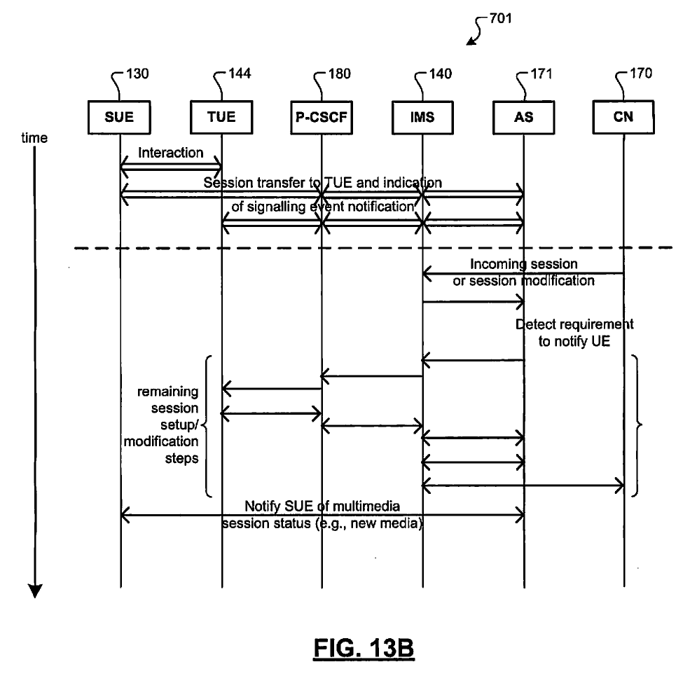

Referring now to FIG. 13A, a block diagram 700 illustrates a method for the core network to originate an IMS communication session setup where the TUEs 144 retain communication session control and the SUE 130 is notified of IMS session status. Further, FIG. 13B illustrates a timeline 701 of steps performed based on the method for IMS communication session setup.

In step 704, the SUE 130 may transfer an IMS communication session to the TUEs 144, as in FIGS. 9A-9B. The TUEs 144 may retain control of the IMS communication session after the transfer. In other words, the SUE 130 may transfer media components to TUEs 144 and not receive incoming IMS session signalling. Therefore, the IMS 140 may respond to the TUEs 144 for communication sessions that occur after transfer of media components.

In step 706, the IMS 140 may receive an incoming session from the core network 170 and set-up the session. The IMS 140 may then send the incoming IMS session signalling to the TUEs 144 in step 708. In step 710, the TUEs 144 may complete session modification. For example, the TUEs 144 may receive the IMS session signalling and accept or decline signalling for media components. The TUEs 144 may accept or decline signalling based on a TUE profile that indicates that the TUEs 144 may not be able to support certain media components. Communications may then continue in step 712 between the TUEs 144 and the IMS 140. The IMS 140 may route the IMS signalling to the TUEs 144 and notify the SUE 130 at the end of the media negotiation in step 720. The TUEs 144 may notify the SUE 130 of events, such as the TUEs 144 accepting or declining IMS signalling related to media components. The TUEs 144 may therefore process the incoming IMS session signalling and may selectively route the IMS signalling to the IMS 140 and not the SUE 130.

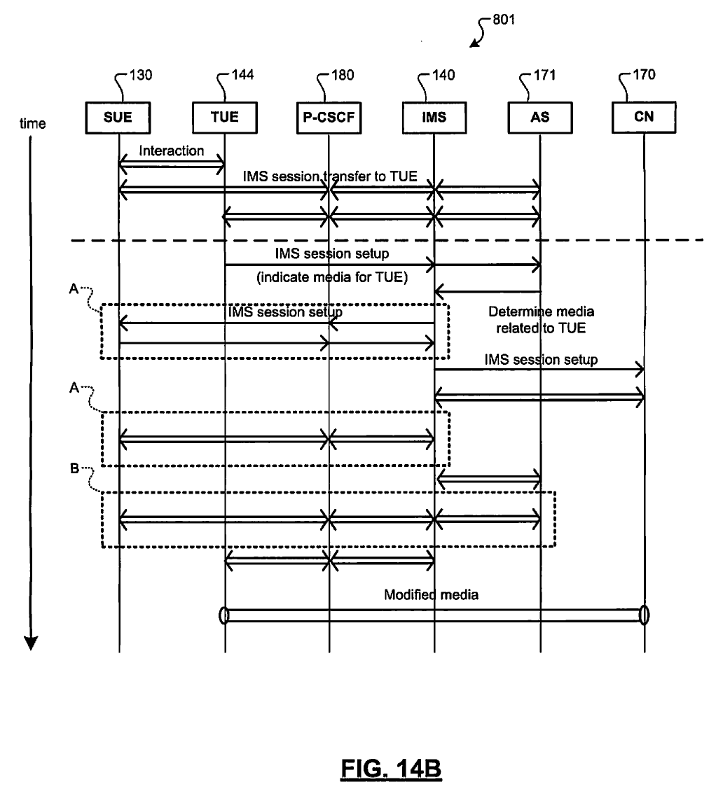

Referring now to FIG. 14A, a block diagram 800 illustrates a method for the TUEs 144 to originate an IMS communication session modification and retain control while the SUE 130 is notified of IMS session status. Further, FIG. 14B illustrates a timeline 801 of steps performed based on the method for IMS communication session modification.

In step 804, the SUE 130 may transfer an IMS communication session to the TUEs 144, as in FIGS. 9A-9B. In step 806, the TUEs 144 may initiate an IMS session modification. The initiating the IMS session signalling by the TUEs 144 towards a correspondent node may include signalling related to a new communication session and/or modification of an existing communication session.

In step 808, the IMS 140 may provide the SUE 130 with the session modification, and the SUE 130 may accept or decline the proposed modification. Two options, labelled as “A” and “B” are illustrated in FIG. 14B for step 808. For option A, all signalling is routed through the SUE 130. For option B, the SUE 130 is merely informed of media information that is to be setup. In step 810, the IMS session modification is completed. The SUE 130 may selectively cause the media modification and/or the IMS communication session to be transferred back to the SUE 130 and/or to other TUEs 144. In step 812, IMS communication sessions may be implemented via the modified media setup.

The IMS 140 may also process the IMS session signalling by determining whether to forward all the IMS session signalling to the SUE 130. The IMS 140 may also process the IMS session signalling by selectively notifying the SUE 130 of the media information as result of the IMS session signalling. When the SUE 130 is notified of the events, the SUE 130 may selectively transfer the media modification and/or the IMS communication session back to the SUE 130 and/or to other TUEs 144.

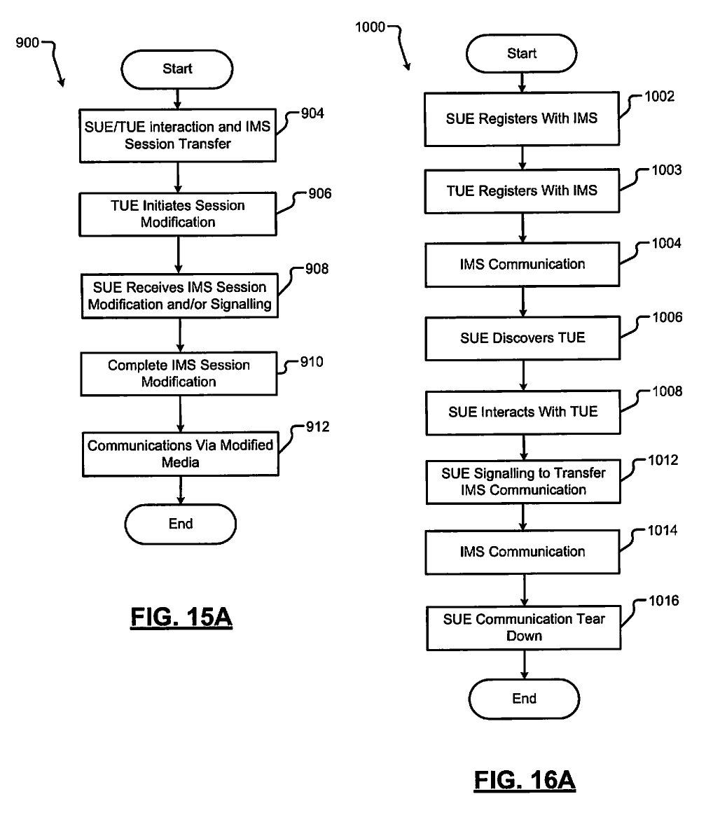

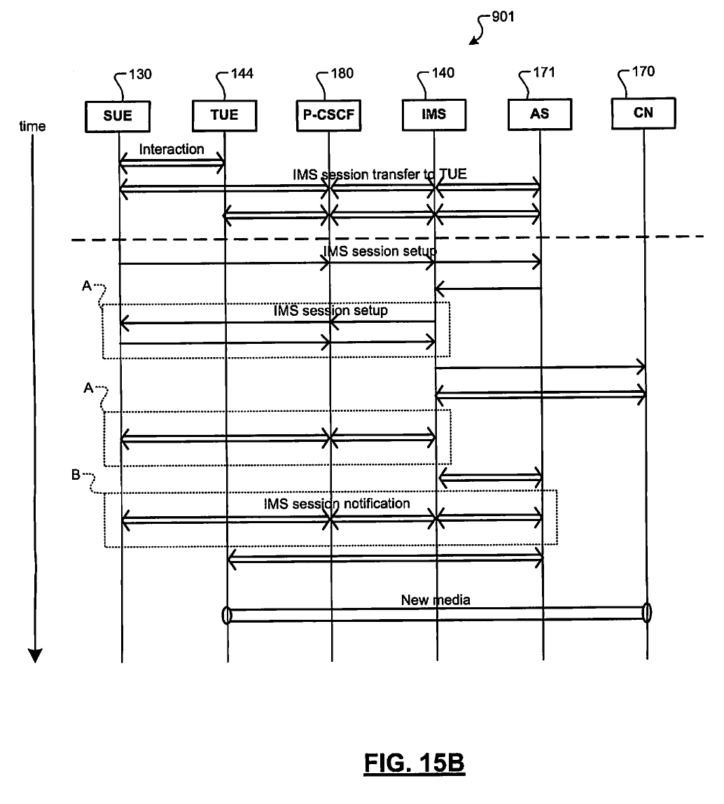

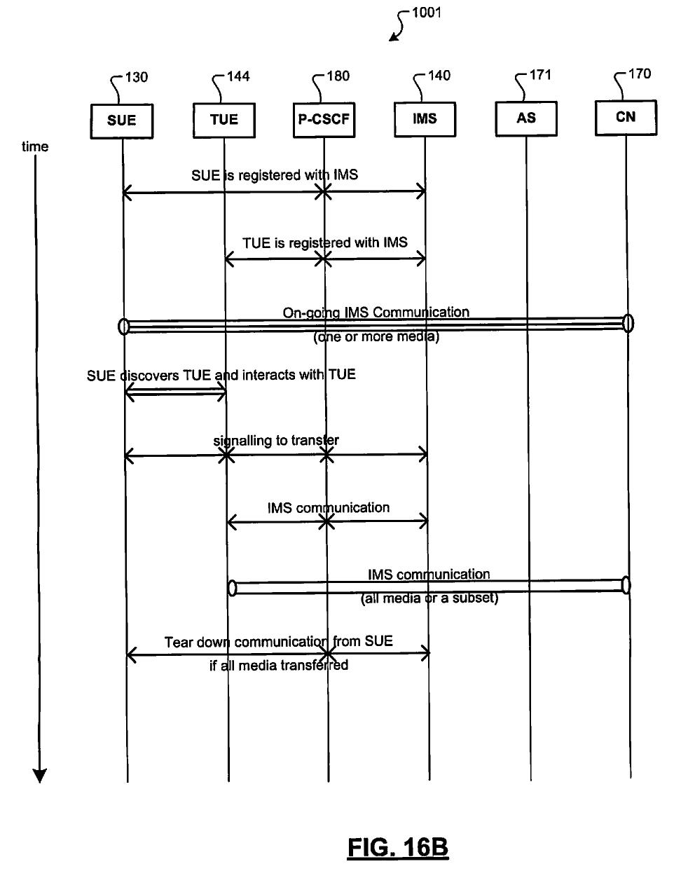

Referring now to FIG. 15A, a block diagram 900 illustrates a method for the SUE 130 to originate an IMS communication session setup where media is routed to the TUEs 144 but the SUE 130 retains control. Further, FIG. 15B illustrates a timeline 901 of steps performed based on the method for IMS communication session setup.

In step 904, the SUE 130 may transfer an IMS communication session to the TUEs 144, as in FIGS. 9A-9B. In step 906, the TUEs 144 may initiate an IMS session setup. The initiating of the IMS session signalling by the SUE 130 towards a correspondent node may include signalling related to a new communication session and/or modification of an existing communication session.

In step 908, the IMS 140 may provide the SUE 130 with the session setup, and the SUE 130 may accept or decline the proposed modification. Two options, labelled as “A” and “B” are illustrated in FIG. 15B for step 908. For option A, all signalling is routed through the SUE 130. For option B, the SUE 130 is merely informed of media information that is to be setup. In step 910, the IMS session modification is completed. The SUE 130 may selectively cause the media modification and/or the IMS communication session to be transferred back to the SUE 130 and/or to other TUEs 144. In step 912, IMS communication sessions may be implemented via the new media. The SUE 130 may therefore remain in control for new outgoing IMS communication sessions and/or for new incoming IMS communication sessions.

Referring now to FIGS. 16A-21B, systems and methods for the SUE 130 to transfer a subset of a communication session to TUEs 144 where the SUE 130 and TUEs 144 may not be under control of the same user are illustrated. The TUEs 14 may or may not be registered with the IMS 140. The TUEs 144 also may or may not have respective credentials to register and/or to establish/receive IP multimedia services from the IP network 120 and/or core network 170. The SUE 130 may interact with the TUEs 144 by providing the TUEs 144 with credentials enabling the TUEs 144 to register with the other networks providing IMS services and to establish IMS communication sessions. The SUE 130 share existing SUE 130 credentials and/or the TUEs 144 and SUE 130 may generate credentials that provide mutual and/or individual access

Referring now to FIG. 16A, a block diagram 1000 illustrates a method for the SUE 130 to transfer a subset of a communication session to TUEs 144 where the TUEs 144 may be registered with the IMS 140. Further, FIG. 16B illustrates a timeline 1001 of steps performed based on the method for IMS media transfer.

In step 1002, the SUE 130 registers with the IMS 140. In step 1003, the TUEs 144 register with the IMS 140. In step 1004, the SUE 130 exchanges IMS communication sessions using one or more types of media components. In step 1006, the SUE 130 discovers the TUEs 144. The SUE 130 may discover the presence of the TUEs 144 based on user input that indicates the presence of the TUEs 144. The SUE 130 may also discover the presence of the TUEs 144 based on a user initiated search for other UEs using, for example, a local connectivity interface, such as an access point. The local connectivity interface may include a Bluetooth interface, an infrared interface, a WLAN, a WIMAX interface, etc.

The local connectivity interface may scan for other UEs and provide an indication to the SUE 130 of the other UEs. The SUE 130 may also discover the presence of TUEs 144 by using presence information, such as presence of the TUEs 144 interacting with the IMS 140. The user may provide identities of TUEs 144. The TUEs 144 may also indicate that the TUEs 144 are registered with other networks providing IMS services. Establishing a relationship between the first UE and other UEs may include the use of a local connectivity interface.

In step 1008 the SUE 130 and TUEs 144 may interact. For example, the SUE 130 and TUEs 144 may exchange security information to allow the SUE 130 to transfer IMS communication sessions to the TUEs 144. Exchanging security information may include the TUEs 144 providing the SUE 130 with security information to be provided to the IMS 140 during the IMS signalling in order to transfer the IMS communication session to the TUEs 144. The security information may include, for example, a token, such as a one-time use token and/or a security association between the SUE 130 and TUEs 144.

The TUEs may be registered with the IMS 140 of a different network than the IP network 120. In step 1012, the SUE 130 may transfer an IMS session to the TUEs 144. In step 1012, the SUE 130 exchanges signalling with the IMS 140 to transfer the IMS communication session to the TUEs 144. In step 1014, the TUEs 144 participate in the IMS communication session using one or more of the media components. In step 1016, the SUE 130 and/or IMS 140 may tear down IMS communication sessions with the SUE 130 if the TUEs 144 are handling all the media components of the IMS communication session. Tearing down communication sessions may include completely transferring communication control to the TUEs 144.

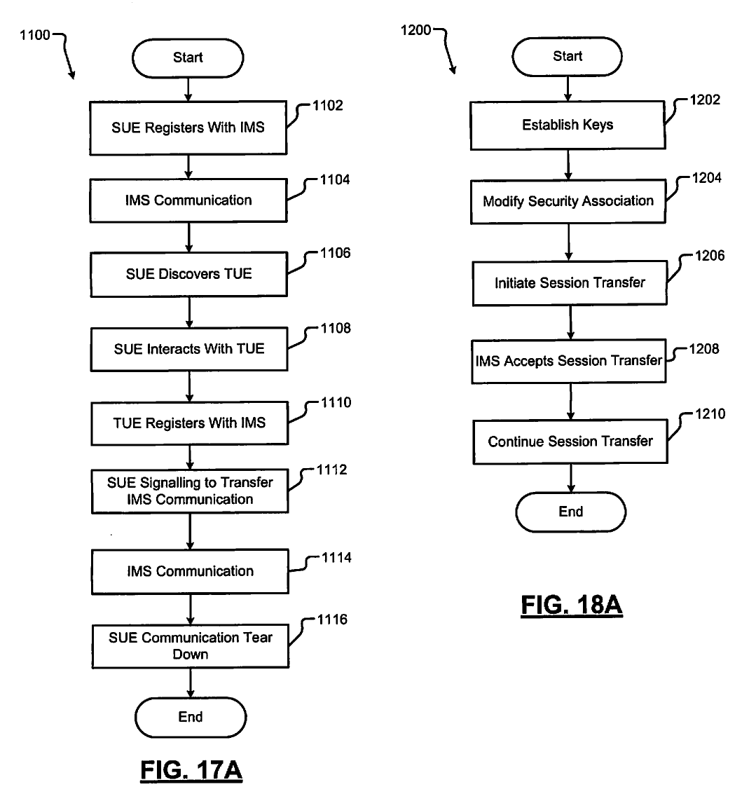

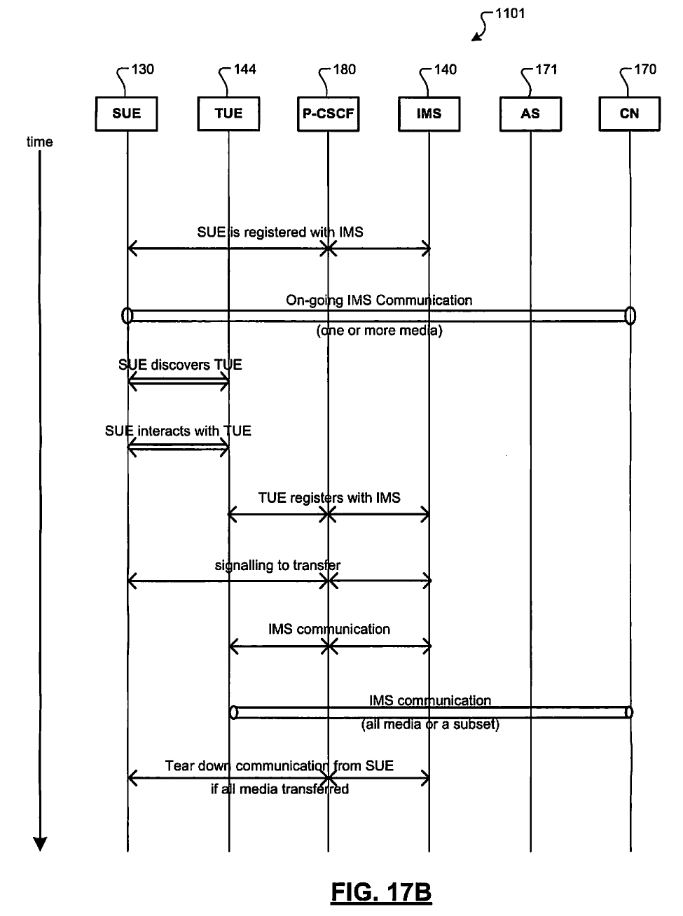

Referring now to FIG. 17A, a block diagram 1100 illustrates a method by which the SUE 130 may transfer a subset of a communication session to TUEs 144 where the TUEs 144 may be registered with the IMS 140. Further, FIG. 17B illustrates a timeline 1101 of steps performed based on the method for IMS media transfer.

In step 1102, the SUE 130 registers with the IMS 140. The TUEs 144 may or may not be registered with an IMS infrastructure of an IP network other than the IP network 120 and may or may not have credentials to register with the IMS 140. In step 1104, the SUE 130 exchanges IMS communication sessions using one or more types of media components. In step 1106, the SUE 130 discovers the TUEs 144. The SUE 130 may discover the presence of the TUEs 144 based on user input that indicates the presence of the TUEs 144. The SUE 130 may also discover the presence of the TUEs 144 based on a user initiated search for other UEs using, for example, a local connectivity interface, such as an access point and/or a gateway. The local connectivity interface may scan for other UEs and provide an indication to the SUE 130 of the other UEs. The SUE 130 may also discover the presence of TUEs 144 by using presence information, such as presence of the TUEs 144 interacting with the IMS 140. The user may provide identities of TUEs 144.

In step 1108 the SUE 130 and TUEs 144 may interact. For example, the SUE 130 and TUEs 144 may exchange security information to allow the SUE 130 to transfer IMS communication sessions to the TUEs 144. Exchanging security information may include the TUEs 144 providing the SUE 130 with a security token to be provided to the IMS 140 during the IMS signalling in order to transfer the IMS communication session to the TUEs 144.

In step 1110, the TUEs 144 may register with the IMS 140. If the TUEs 144 are already registered with an IMS infrastructure of another IP network, the TUEs 144 may register with the IMS 140 via the other IMS infrastructure(s). In step 1112, the SUE 130 may transfer an IMS session to the TUEs 144. In step 1012, the SUE 130 exchanges signalling with the IMS 140 to transfer the IMS communication session to the TUEs 144. In step 1114, the TUEs 144 participate in the IMS communication session using one or more of the media components. In step 1116, the SUE 130 and/or IMS 140 may tear down IMS communication sessions with the SUE 130 if the TUEs 144 are handling all the media components of the IMS communication session. Tearing down communication sessions may include completely transferring communication session control to the TUEs 144.

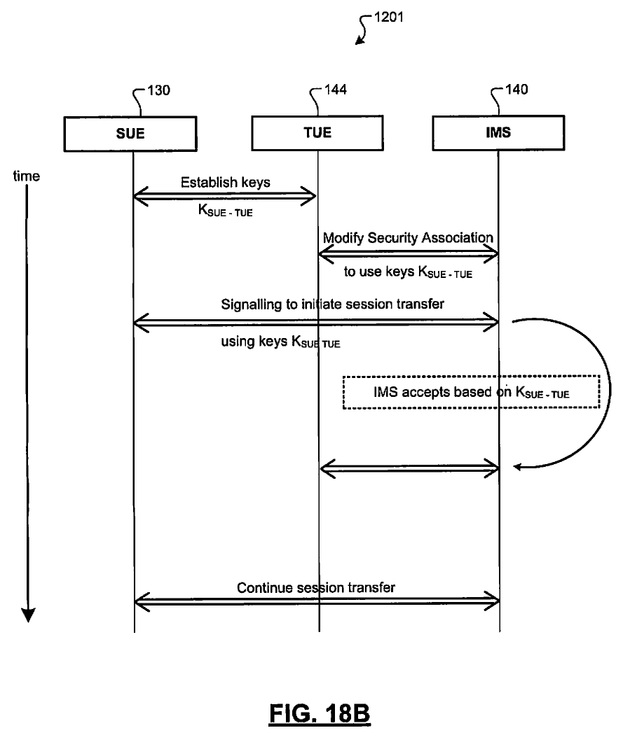

Referring now to FIG. 18A, a block diagram 1200 illustrates a method for exchanging security information between the SUE 130 and the TUEs 144 where the TUEs 144 may be registered with the IMS 140 or an IMS infrastructure of a different IP network. Further, FIG. 18B illustrates a timeline 1201 of steps performed based on the method for security exchange.

In step 1202, the SUE 130 and the TUEs 144 communicate and exchange security information. For example, the SUE 130 and TUEs 144 may mutually exchange information so that when the TUEs 144 receive requests from the SUE 130, the TUEs 144 may accept the requests because the TUEs 144 are aware that the requests are safe. Alternatively, a security key and/or token may be physically exchanged between the SUE 130 and TUEs 144.

In step 1204, exchanging security information may include the TUEs 144 modifying the respective security association they share with the IMS 140 or with other networks providing IMS services. The TUEs 144 may provide security keys to the SUE 130 that the SUE 130 may use to initiate transfer the IMS communication session to the TUEs 144 in step 1206. In step 1208, the IMS 140 of the IP network 120 or the IMS infrastructure of the other networks may accept or deny the transfer of the IMS communication session to the TUEs 144 based on the security keys. In step 1210, session transfer continues.

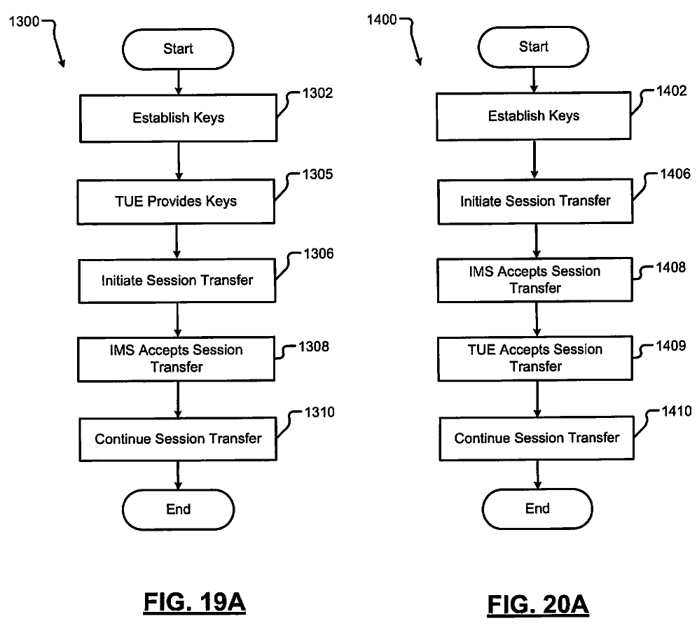

Referring now to FIG. 19A, a block diagram 1300 illustrates a method for exchanging security information between the SUE 130 and the TUEs 144 where the TUEs 144 may be registered with the IMS 140 or an IMS infrastructure of a different IP network. Further, FIG. 19B illustrates a timeline 1301 of steps performed based on the method for security exchange.

In step 1302, the SUE 130 and the TUEs 144 communicate and exchange security information. For example, the SUE 130 and the TUEs 144 may establish security keys, and the TUEs 144 may provide the security keys to the other networks providing IMS services to the TUEs 144. The TUEs 144 may have established a security association with the IMS 140 and may protect data exchanges via the security association. In step 1305, the TUEs 144 may provide the security keys to the IMS 140 of the IP network 120 and/or the other networks that the TUEs 144 communicate with. The other networks and/or IMS 140 may accept or deny the transfer of the IMS communication session to the TUEs 144 based on the security keys.

The TUEs 144 may provide security keys to the SUE 130 that the SUE 130 may use to initiate transfer of the IMS communication session to the TUEs 144 in step 1306. Alternatively, the TUEs 144 may initiate transfer of signalling. For example, the SUE 130 may instruct the TUEs 144 to initiate the signalling. In step 1308, the IMS 140 of the IP network 120 or the IMS infrastructure of the other networks may accept or deny the transfer of the IMS communication session to the TUEs 144 based on the security keys and/or security association of the TUEs 144 and IMS 140. In step 1310, session transfer continues.

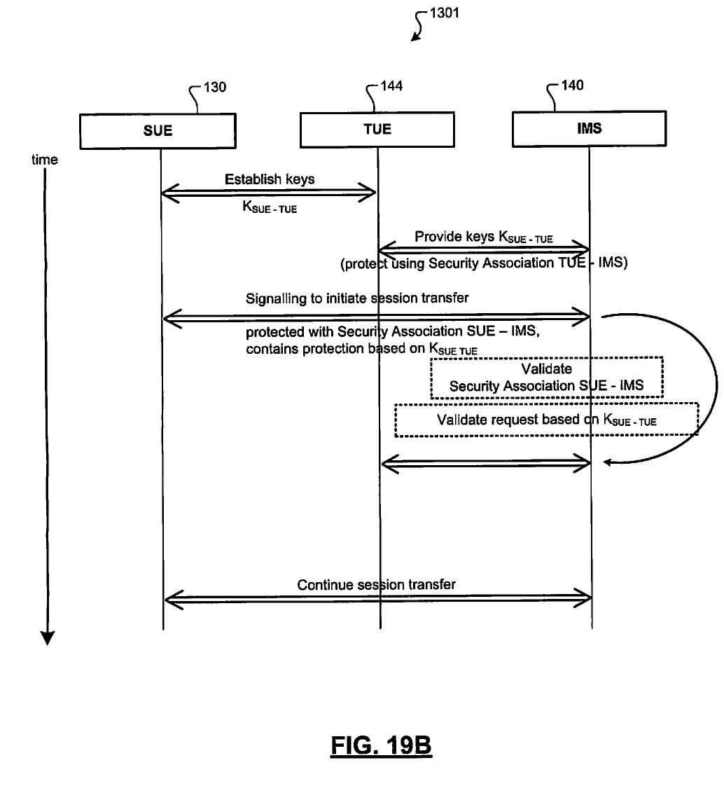

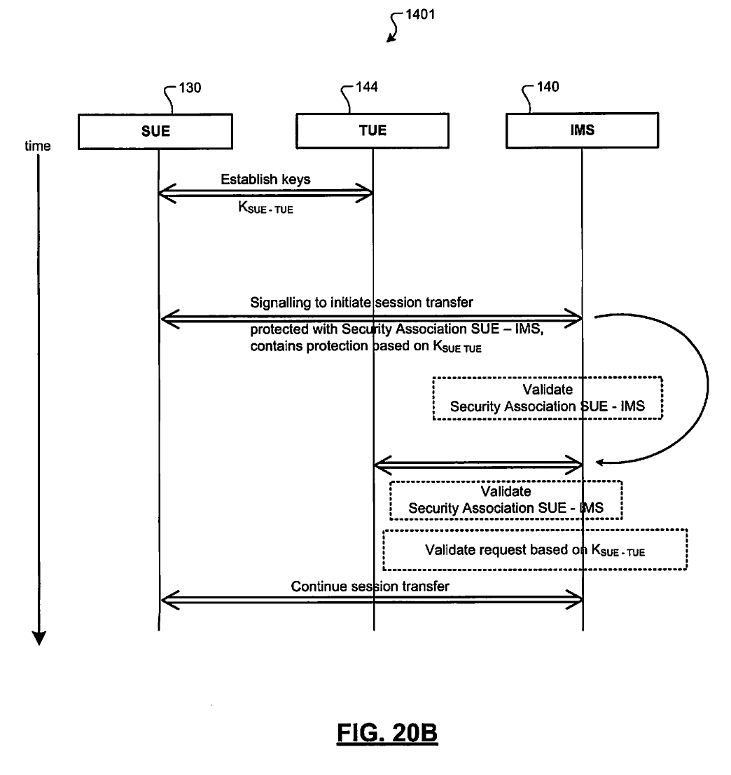

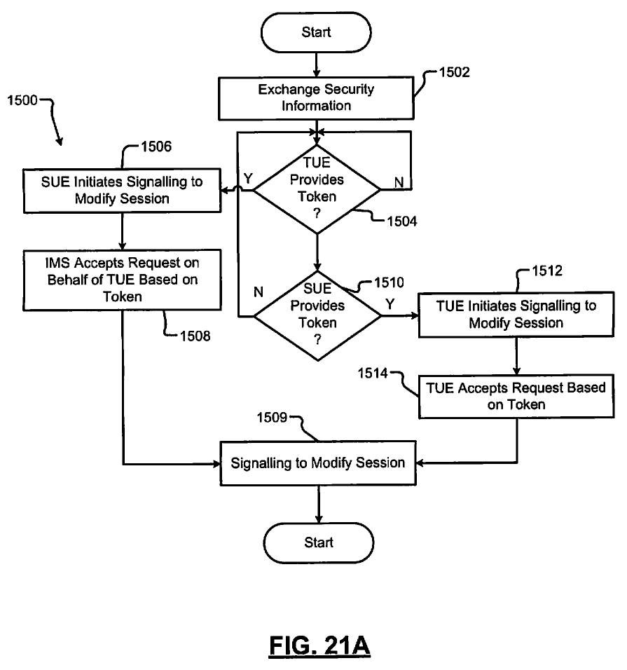

Referring now to FIG. 20A, a block diagram 1400 illustrates a method for exchanging security information between the SUE 130 and the TUEs 144 where the TUEs 144 may be registered with the IMS 140 or an IMS infrastructure of a different IP network. Further, FIG. 20B illustrates a timeline 1401 of steps performed based on the method for security exchange. The SUE 130 may have a security association setup with the IMS 140.

In step 1402, the SUE 130 and the TUEs 144 communicate and exchange security information. For example, the SUE 130 and the TUEs 144 may establish security keys, and the TUEs 144 may provide the security keys and/or the security association to the other networks providing IMS services to the TUEs 144. The SUE 130 may provide the security keys and/or security association to the IMS 140 of the IP network 120 and/or the other networks that the TUEs 144 communicate with. The other networks may accept or deny the transfer of the IMS communication session to the TUEs 144 based on the security keys and/or security association.

The TUEs 144 may provide security keys to the SUE 130 that the SUE 130 may use when initiating transfer of the IMS communication session to the TUEs 144 in step 1406. In step 1408, the IMS 140 of the IP network 120 or the IMS infrastructure of the other networks may accept or deny the transfer of the IMS communication session to the TUEs 144 based on the security keys and/or security association. In step 1410, session transfer continues. In step 1409, the TUEs 144 may also accept or deny the transfer of the IMS communication session to the TUEs 144 based on the security keys and/or security association.

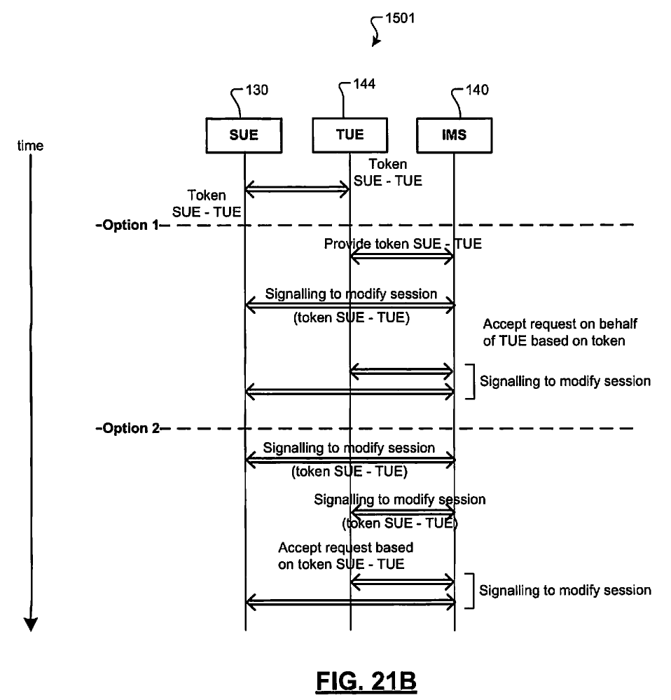

Referring now to FIG. 21A, a block diagram 1500 illustrates a method for exchanging security information between the SUE 130 and the TUEs 144 where the TUEs 144 may be registered with the IMS 140 or an IMS infrastructure of a different IP network. Further, FIG. 21B illustrates a timeline 1501 of steps performed based on the method for security exchange. In FIGS. 21A-21B, security keys are not provided, instead a token, such as a one-time use token is exchanged between the SUE 130 and TUEs 144 and then carried over for subsequent communication sessions.

In step 1502, the SUE 130 and the TUEs 144 communicate and exchange security information. In step 1504, the TUEs 144 provide the token to the IMS 140. The IMS 140 may comment on and/or validate the request. In step 1506, the SUE initiates signalling to modify the IMS session. In step 1508, the IMS 140 accepts the request on behalf of the TUEs 144 based on the token. In step 1509, signalling is exchanged to modify the session.

Alternatively, in step 1510, the SUE 130 includes the token in signalling with the IMS 140 to modify the session. The token may be carried through future signalling. The IMS 140 may not be aware of the token during signalling and may relay signalling to the TUEs 144 independent of the token. In step 1512, the TUEs 144 receives the token during signalling. In step 1514, the TUE accepts or declines a request to use the TUEs 144 from the IMS 140 based on the token. In step 1509, signalling is exchanged to modify the session.

Those skilled in the art can now appreciate from the foregoing description that the broad teachings of the disclosure can be implemented in a variety of forms. Therefore, while this disclosure includes particular examples, the true scope of the disclosure should not be so limited since other modifications may be made upon a study of the drawings, the specification, and the following claims.

What is claimed is:

1. A source communication terminal comprising:
a communication module that initiates a first communication with a first remote terminal via first Internet protocol (IP) multimedia subsystems (IMS) of a first IP network, wherein the first communication includes X media components;
a media transfer module that transfers Y of the X media components to a first target terminal of Z target terminals during the first communication; and
a control module that provides an indication to the first IMS of a control model for the first communication,
wherein the control model is implemented after the Y media components have been transferred to the first target terminal, wherein the control model identifies at least one of the source communication terminal and the first target terminal that controls IMS signalling for the first communication, and wherein X, Y and Z are integers greater than or equal to 1, and wherein Y is less than or equal to X.

2. The source communication terminal of claim 1, wherein the media transfer module transfers M-Y of the X media components to a second target terminal of the Z target terminals during the first communication.

3. The source communication terminal of claim 1, wherein the media transfer module transfers a first media component of the X media components to a second target terminal of the Z target terminals and a second media component of the X media components to a third target terminal of the Z target terminals during the first communication.

4. The source communication terminal of claim 1, further comprising a receive module that receives the IMS signalling based on the control model.

5. The source communication terminal of claim 4, wherein the receive module receives the IMS signalling independent of whether the source communication terminal or the first target terminal controls the IMS signalling for the first communication.

6. The source communication terminal of claim 4, further comprising a processing module that processes the IMS signalling and that forwards the IMS signalling to the first target terminal.

7. The source communication terminal of claim 6, further comprising a decision module that determines whether to accept the IMS signalling based on negotiations between the source communication terminal and the first target terminal.

8. The source communication terminal of claim 1, wherein the source communication terminal further comprises a session module that initiates the IMS signalling after the transfer of the Y of the X media components and that provides the IMS signalling to the first IMS, wherein the IMS signalling includes signalling for communication with at least one of the first remote terminal and a second remote terminal.

9. The source communication terminal of claim 1, further comprising a security module that exchanges security information with the first target terminal.

10. The source communication terminal of claim 9, wherein the exchanges of the security information include the source communication terminal receiving at least one token from the first target terminal, wherein the security module provides the first IMS with the at least one token during the IMS signalling.

11. A network system comprising the source communication terminal of claim 1 and further comprising:
the first IP network comprising the first IMS; and
the Z target terminals.

12. The network system of claim 11, wherein at least one of the first IMS and the Z target terminals store the control mode, and the first IMS selects the control model based on the indication from the source communication terminal.

13. The network system of claim 11, wherein the first target terminal receives the IMS signalling from at least one of the first IMS and the source communication terminal.

14. The network system of claim 13, wherein the source communication terminal provides at least one of an indication to the first target terminal that the IMS signalling is accepted by the source communication terminal and an instruction from the source communication terminal as to how the first target terminal should handle the IMS signalling.

15. The network system of claim 11, wherein the first IMS selectively notifies at least one of the source communication terminal and the first target terminal of incoming IMS signalling for at least one of a first communication and a second communication from at least one of the first remote terminal and a second remote terminal.

16. The network system of claim 11, wherein at least one of the first IMS and the first target terminal notifies the source communication terminal of changes to the first communication after the Y of the X media components have been transferred to the first target terminal.

17. The network system of claim 16, wherein the changes include at least one of a change in control of one of the X media components, an addition of a media component to the first communication and a subtraction of one of the X media components from the first communication.

18. The network system of claim 17, further comprising a second IP network including a second IMS wherein the first target terminal communicates with the second IMS.

19. The network system of claim 18, wherein the first target terminal exchanges security data with the source communication terminal and wherein the source communication terminal provides at least one of the first IMS and the second IMS with the security data during IMS signalling for the first communication.

20. The network system of claim 19, wherein the security data includes at least one of a security token that originates from one of the source communication terminal and the first target terminal, a security key established between the source communication terminal and the first target terminal, and a security association between the source communication terminal and the first target terminal.

21. The network system of claim 19, wherein the first target terminal includes a credential that identifies the first target terminal, wherein the first target terminal is registered with the second IMS and not the first IMS, and wherein the second IMS provides IMS services based on the credential.

22. A method for operating a source communication terminal comprising:
initiating a first communication with a first remote terminal via first Internet protocol (IP) multimedia subsystems (IMS) of a first IP network, wherein the first communication includes X media components;
transferring Y of the X media components to a first target terminal of Z target terminals during the first communication;
providing an indication to the first IMS of a control model for the first communication; and
implementing the control model after the Y media components have been transferred to the first target terminal, wherein the control model identifies at least one of the source communication terminal and the first target terminal that controls IMS signalling for the first communication, and wherein X, Y and Z are integers greater than or equal to 1, and wherein Y is less than or equal to X.

23. The method of claim 22, further comprising transferring M-Y of the X media components to a second target terminal of the Z target terminals during the first communication.

24. The method of claim 22, further comprising transferring a first media component of the X media components to a second target terminal of the Z target terminals and a second media component of the X media components to a third target terminal of the Z target terminals during the first communication.

25. The method of claim 22, further comprising receiving the IMS signalling based on the control model.

26. The method of claim 25, further comprising receiving the IMS signalling independent of whether the source communication terminal or the first target terminal controls the IMS signalling for the first communication.

27. The method of claim 25, further comprising processing the IMS signalling and forwarding the IMS signalling to the first target terminal.

28. The method of claim 27, further comprising determining whether to accept the IMS signalling based on negotiations between the source communication terminal and the first target terminal.

29. The method of claim 22, further comprising initiating the IMS signalling after the transfer of the Y of the X media components and providing the IMS signalling to the first IMS, wherein the IMS signalling includes signalling for communication with at least one of the first remote terminal and a second remote terminal.

30. The method of claim 22, further comprising exchanging security information with the first target terminal.

31. The method of claim 30, wherein the exchanges of the security information include the source communication terminal receiving at least one token from the first target terminal, and providing the first IMS with the at least one token during the IMS signalling.

32. The method of claim 22, further comprising the first IMS selecting the control model based on the indication from the source communication terminal.

33. The method of claim 22, further comprising receiving the IMS signalling from at least one of the first IMS and the source communication terminal.

34. The method of claim 33, further comprising providing at least one of an indication to the first target terminal that the IMS signalling is accepted by the source communication terminal and an instruction from the source communication terminal as to how the first target terminal should handle the IMS signalling.

35. The method of claim 22, further comprising receiving notification of incoming IMS signalling for at least one of a first communication and a second communication from at least one of the first remote terminal and a second remote terminal.
